(19) United States
(12) Patent Application Publication
(10) Pub. No.: US 2021/0293356 A1
(43) Pub. Date: Sep. 23, 2021

(54) Bracket with a Clamp, in Particular a Clamp for a Surveying Rod

(71) Applicant: Glenn AYALA, Anchorage, AK (US)

(72) Inventor: Glenn AYALA, Anchorage, AK (US)

(21) Appl. No.: 16/694,640

(22) Filed: Nov. 25, 2019

(51) Int. Cl. F16L 3/10

(52) U.S. Cl. CPC F16L 3/1075

(57) ABSTRACT

Bracket may include a clamp. A left connector and a right connector may be provided on the clamp. A left fastener may be provided on the left connector, and a right fastener may be provided on the right connector. Bracket may include an interior, and a padding may be provided on the interior. Bracket may include a first half and a second half, and a hinge may be provided between the first half and the second half. First half is movable about the hinge relative to the second half. A pin secures the first half to the second half. Pin may be a pull pin.

### FIELD OF THE INVENTION

The invention relates to a bracket. More particularly, the present invention relates to a bracket having a clamp. Even more particularly, the invention is suited for being attached to a rod; i.e., clamped to a carbon fiber reinforced plastic (CFRP) rod of a piece of a surveying equipment.

### SUMMARY OF THE INVENTION

A bracket including a clamp, a left connector and a right connector. There may be a left fastener provided on the left connector, and a right fastener provided on the right connector. The bracket may include an interior, and a padding may be provided on the interior. The bracket may include a first half and a second half, and a hinge may be provided between the first half and the second half.

The first half may be movable about the hinge relative to the second half.

A pin may secure the first half to the second half.

The pin may be a spring-loaded pull pin.

The left connector may be provided on the first half.

The right connector may be provided on the first half.

The padding may include a plastic.

The padding may include a polyurethane.

The hinge may include a hinge pin, and the hinge pin may have no head, as shown.

Relative terms such as left, right, up, and down are for convenience only and are not intended to be limiting.

### BRIEF DESCRIPTION OF THE DRAWINGS

FIG. 1 is a front view of a bracket according to the invention;

FIG. 2 is a rear view of a bracket according to the invention of FIG. 1;

FIG. 3 is a top view of a bracket according to the invention of FIG. 1 with a closed clamp; and

FIG. 4 is a top view of a bracket according to the invention of FIG. 1 with an open clamp.

### DETAILED DESCRIPTION OF THE INVENTION

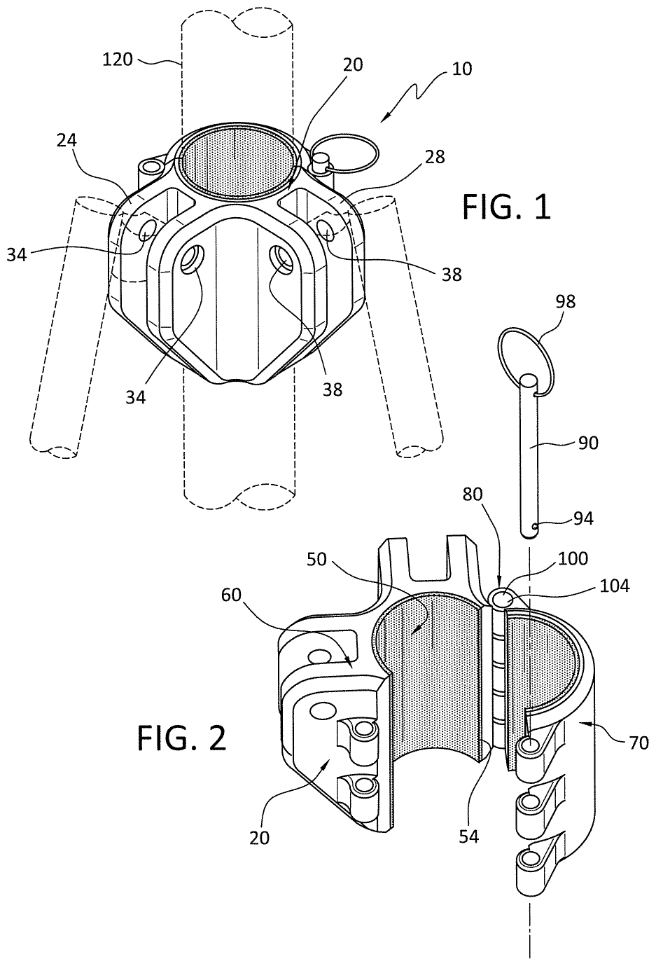

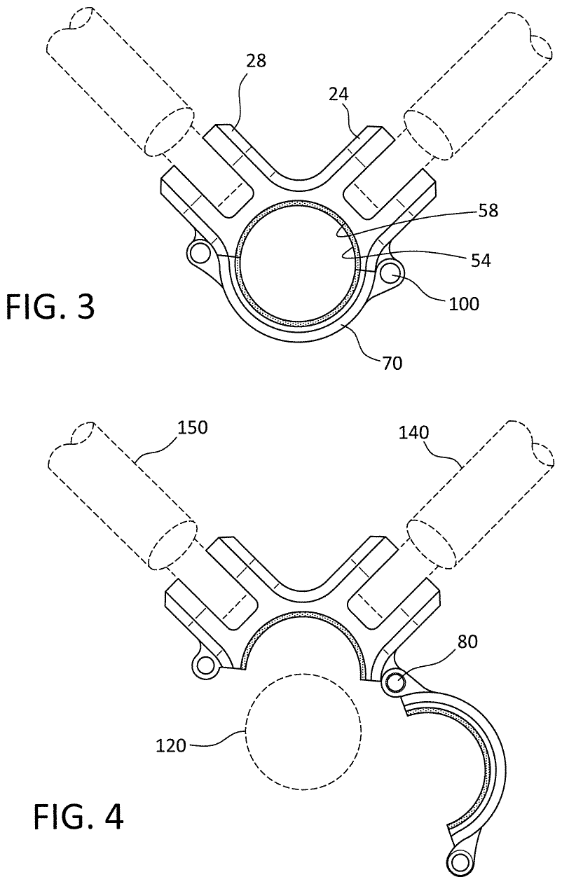

FIGS. 1-4 show a bracket 10 according to the invention.

FIG. 1 is a front view of bracket 10 according to the invention in a closed position.

The bracket 10 may include a clamp 20. A left connector 24 and a right connector 28 may be provided on clamp 20. A left fastener 34 may be provided on the left connector 24, and a right fastener 38 may be provided on right connector 28.

Bracket 10 may include an interior 50, and a padding 54 may be provided on a face 58 of interior 50.

FIG. 2 is a rear view of bracket 10 according to the invention in an open position.

Bracket 10 may include a first half 60 and a second half 70, and a hinge 80 may be provided between the first half 60 and the second half 70. First half 60 is movable about hinge 80 relative to second half 70, and first half 60 works with second half 70 to clamp an object, such as a rod, as explained in greater detail below.

A pin 90 may secure first half 60 to second half 70. The pin 90 may be a spring-loaded pull pin 90 having a spring-loaded release 94. Spring-loaded release 94 may be a spring-loaded ball or cylinder. A ring 98 may be provided on pin 90 to assist as user in removing pin 90 when clamp 20 is to be opened.

The hinge 80 may include a hinge pin 100, and the hinge pin 100 may have no head at a top end 104 of hinge pin 100, as shown.

Left connector 24 may be provided on first half 60; and, right connector 28 may be provided on first half 60.

Padding 54 may include a plastic; for example, padding 54 may include a polyurethane.

The padding 54 may have a hardness depending on the intended use. For example, a polyurethane foam material having a desired Shore hardness, such as a 95A Shore hardness may be used.

In use, clamp 20 may be used to clamp around a pole, such as a rod 120, which may be a survey rod attached to an unillustrated surveying instrument. In the case of clamping survey rod 120, there is typically a left support 140 and a right support 150 forming a bipod which supports the rod 120 of the surveying equipment.

In detail, pull pin 90 is moved up sufficiently to open clamp 20, so that second half 70 may move about hinge 80 away from first half 60.

Then, an object to be clamped, such as a rod 120 may located in interior 50 of clamp 20. Padding 54 helps hold rod 120 in place in clamp 20 when the clamp is closed by moving second half back to its securing position adjacent first half 60. Pin 90 is then moved downwardly into its securing position between the first and second halves of clamp 20.

Thus, the rod 120, such as a survey rod, is supported and secured by clamp 20 on bracket 10 without crushing rod 120, as occurs with existing clamps. Clamped rod 120 is thus held by bracket 10 in its use position attached to left support 140 and right support 150.

It can thus be seen that the clamp of the bracket according to the invention is suited for being attached to a rod of a piece of a surveying equipment; and, indeed, clamped to a carbon fiber reinforced plastic (CFRP) rod. It will be appreciated that the clamp is suited for being attached to a steel or aluminum rod.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention.

What is claimed is:

1. A bracket, comprising:
a) a clamp, the clamp being configured for being clamped to a carbon fiber reinforced plastic survey rod;
b) a left connector and a right connector being provided on the clamp;
c) a left fastener being provided on the left connector, and a right fastener being provided on the right connector;
d) the bracket including an interior;
e) a padding being provided on the interior, the padding including a plastic;
f) the bracket including a first half and a second half;
g) a hinge being provided between the first half and the second half;
h) the hinge including a hinge pin having no head at a top end; and
i) a pin securing the first half and the second half, the pin being a spring-loaded pull pin having a spring-loaded release, and the spring-loaded release being a spring-loaded ball.

2. The bracket as set forth in claim 1, wherein:
a) The first half is movable about the hinge relative to the second half.

3. (canceled)

4. (canceled)

5. The bracket as set forth in claim 1, wherein:
a) the left connector is provided on the first half.

6. The bracket as set forth in claim 5, wherein:
a) the right connector is provided on the first half.

7. (canceled)

8. The bracket as set forth in claim 1, wherein:
a) the padding includes a polyurethane.

9. (canceled)

10. (canceled)

11. The bracket as set forth in claim 1, wherein:
a) a carbon fiber reinforced plastic survey rod is clamped to the clamp configured for being clamped to a carbon fiber reinforced plastic survey rod.
